(19) United States
(12) Patent Application Publication
(10) Pub. No.: US 2015/0377744 A1
(43) Pub. Date: Dec. 31, 2015

(54) SYSTEMS AND METHODS FOR PREDICTING THE PERFORMANCE OF A VACUUM UNIT ON A MATERIAL

(71) Applicant: The Procter & Gamble Company, Cincinnati, OH (US)

(72) Inventors: Rakesh Gummalla, Cincinnati, OH (US); Matthew Joseph Macura, Loveland, OH (US); Michael Wayne Taylor, Springdale, OH (US); Carlo Maria Campelli, Crailsheim (DE)

(21) Appl. No.: 14/750,526

(22) Filed: Jun. 25, 2015

Related U.S. Application Data
(60) Provisional application No. 62/018,201, filed on Jun. 27, 2014.

(51) Int. Cl. G01M 99/00; B65G 47/91

(52) U.S. Cl. CPC G01M 99/005; B65G 47/917

(57) ABSTRACT

A system for predicting the performance of a vacuum unit on a material being transported or held within a manufacturing process is disclosed. The system includes a vacuum unit having a vacuum source, a vacuum interface, and a vacuum interface design. The system further includes a material and a computing device comprising a processor and a memory component, wherein the memory component stores logic that, when executed by the processor, causes the system to perform a series of steps that simulate the system and analyze one or more factors to determine if the current vacuum design and vacuum source are balanced for the given material.

### FIELD OF THE INVENTION

The present application relates generally to systems and methods for predicting the performance of a vacuum unit used in the manufacturing of articles.

### BACKGROUND OF THE INVENTION

Vacuum is often used in the manufacturing of articles to a portion of an article or to move the articles from one location to another. For example, during the manufacturing of absorbent articles, an article may be placed in contact with the unit operation equipment which is intended to hold the article on the unit equipment using vacuum as the unit transfers the article to another portion of the manufacturing process. These transfers are done at rapid speeds and therefore have very little margin for error. Vacuum has been used in the past to handle discrete parts with equipment such as vacuum feet, cut & slip units, servo patch placers, and turn & re-pitch units, conveyors, drums; among others.

Design of these vacuum units has traditionally been done using trial and error. Although some modeling has been done in the past using finite element analysis, the analysis may take several weeks to complete.

As such, there remains a need for a method that models a vacuum unit in an efficient manner while eliminating the use of trial and error. The model may be correlated to a unit used in a process such that one may change the vacuum unit, depending on the process.

### SUMMARY OF THE INVENTION

A system for predicting the performance of a vacuum unit on a material being transported or held within a manufacturing process, having one or more vacuum units, a material, and a computing device. The vacuum unit has a vacuum source, a vacuum interface, and a vacuum interface design. The computer has a processor and a memory component. The memory component stores logic that, when executed by the processor, causes the system to perform at least the following: receive an image of the vacuum interface design; receive one or more input properties of the material, the manufacturing process, the manufacturing process conditions, the vacuum unit or combinations thereof; simulate the vacuum unit in contact with the material based on the inputs regarding the material and the manufacturing process; output an analysis in the form of an image file, a text file, or an image file and a text file; and analyze one or more factors to determine if the current vacuum design and vacuum source are balanced for the given material and/or product containing one or more materials.
A method of simulating a vacuum unit on a material being transported or held within a manufacturing process using a computing device. The computer has a processor and a memory component. The memory component stores logic that, when executed by the processor, causes the system to perform at least the following: receive an image of the vacuum interface design; receive one or more input properties of the material, the manufacturing process, the manufacturing process conditions, the vacuum unit or combinations thereof; simulate the vacuum unit in contact with the material based on the inputs regarding the material and the manufacturing process; output an analysis in the form of an image file, a text file, or an image file and a text file; and analyze one or more factors to determine if the current vacuum design and vacuum source are balanced for the given material and/or product containing one or more materials.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a portion of a manufacturing process environment, according to embodiments disclosed herein;

FIG. 2 depicts an overhead view of a vacuum unit interface design with a vacuum pattern, according to embodiments disclosed herein;

FIG. 3 depicts an overhead view of a pre-process vacuum unit interface design with a vacuum pattern, according to embodiments disclosed herein;

FIG. 4 depicts a flowchart for image imprinting on a web process, according to embodiments disclosed herein;

FIG. 5 depicts a text output of the simulation; and

FIG. 6 depicts a user computing device that may be utilized for predicting the performance of a vacuum unit on a material and/or product in manufacturing, according to embodiments disclosed herein.

### DETAILED DESCRIPTION OF THE INVENTION

Embodiments disclosed herein include systems and methods for predicting the performance of a vacuum unit used in manufacturing of articles. Specifically, embodiments disclosed herein may be utilized to determine the appropriate inputs for a vacuum unit to transfer materials and/or products during manufacturing.

The inventors have found that a simulation using an image input, an image output, and first principles calculations instead of trial and error, finite analysis simulations, or combinations thereof, allows for a screening tool that can be used against the three most common failure modes experienced in vacuum unit and vacuum pattern-design. Specifically, the analysis and optimization simulation allows a user to confirm that there is enough vacuum force for a material to stay attached to the vacuum interface, to confirm there is no possibility of edge-lift off by the material from the vacuum unit interface for the given material, and to test against possible excessive deflection into the vacuum interface design holes. The simulation may be run using a python script, which works on multiple platforms such as, for example, Windows, Mac, Linux, mobile OS, etc.

The vacuum unit may be any equipment that uses vacuum in a manufacturing process or in a step of a manufacturing process such as, for example, vacuum feet, cut & slip units, servo patch placers, and turn & re-pitch units, conveyors, drums; among others.

The material may be a substrate, a portion of an absorbent article, or an absorbent article. An absorbent article may be any article able to receive and/or absorb and/or contain and/or retain body fluids/bodily exudates such as menses, vaginal secretions, and urine. Exemplary absorbent articles in the context of the present invention are disposable feminine hygiene absorbent articles, diapers, wound dressings, sanitary napkins, panty liners, absorbent articles for adult incontinence, paper towels, facial tissues, floor wipes, bath tissues, countertop wash, body wipes, baby wipes, feminine wipes, toilet paper, household wipes, foam or the like. The term “disposable” is used herein to describe articles, which are not intended to be laundered or otherwise restored or reused as an article (i.e. they are intended to be discarded after a single use and preferably to be recycled, composted or otherwise disposed of in an environmentally compatible manner). Absorbent articles include any type of structures, from a single absorbent layer to more complex multi-layer structures. Absorbent articles according to the present invention can typically comprise a topsheet, a backsheet and an absorbent core.

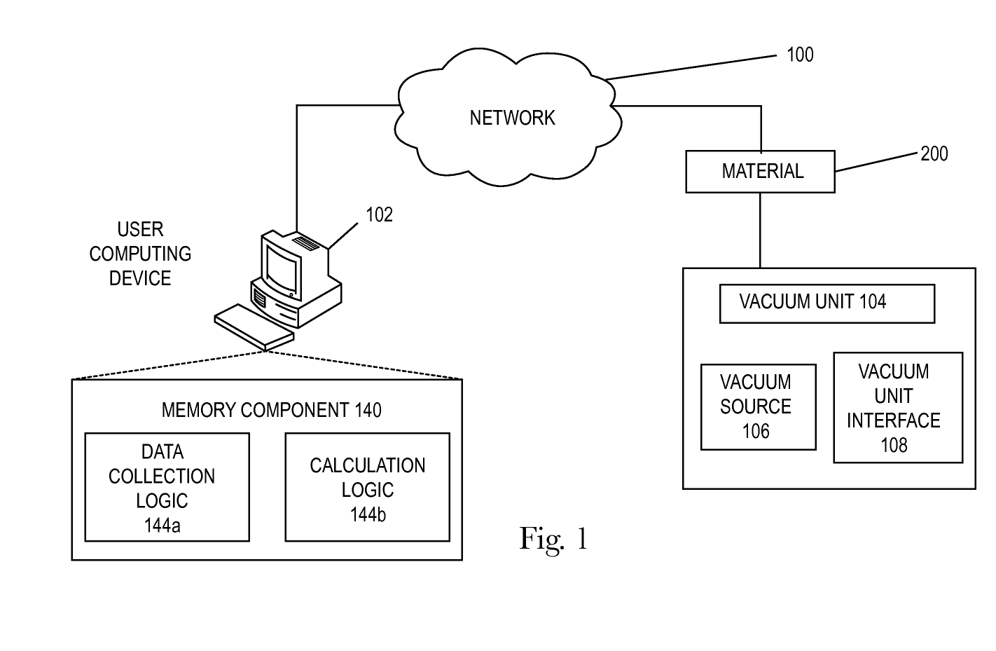

Referring now to the drawings, FIG. 1 depicts a vacuum unit, according to embodiments disclosed herein. The vacuum unit 104 has a vacuum source 106, and a vacuum interface 108. As illustrated, a network 100 is coupled to a user computing device 102 and a unit connected to the vacuum unit 104. The user computing device 102 may include a memory component 140 that stores data gathering logic 144a and calculation logic 144b. As described in more detail below, the data gathering logic 144a may cause the user computing device 102 (when executed by a processor) to determine the parameters described below. These parameters may be determined via a user input, a sensor input, and/or via other mechanisms. Additionally, the calculation logic 144b may cause the user computing device 102 to perform one or more calculations for determining the appropriate process setting including the appropriate vacuum range.

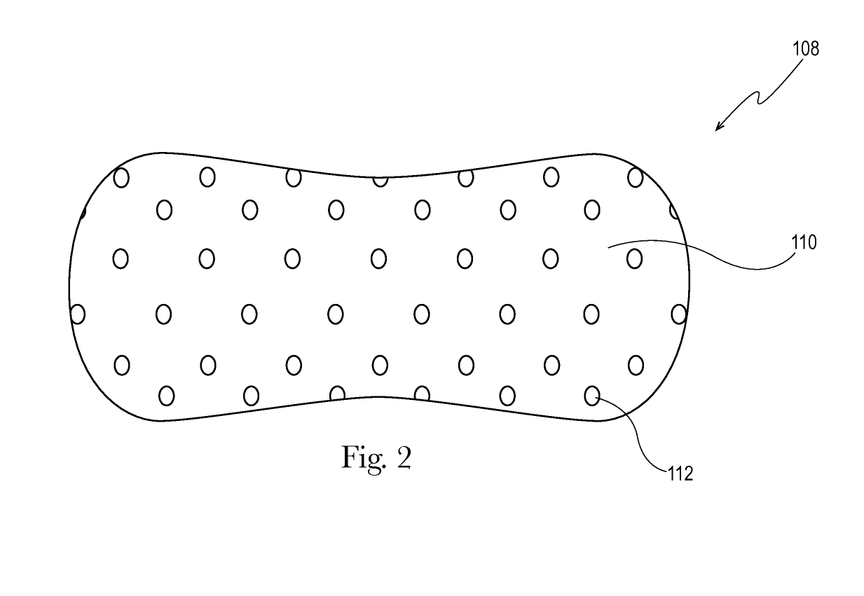

The vacuum unit interface 108 may interact with a material 200 in the form of a substrate, a portion of an absorbent article, or an absorbent article, which travels through a manufacturing process 100. As shown in FIG. 2, the vacuum unit interface 108 has a design 110 which may have one or more vacuum holes 112 through which vacuum is drawn. The vacuum unit 104 may be configured for communicating with the user computing device 102, such as via a computing device on the vacuum unit 104. Regardless of the mechanism, the user computing device 102 may receive information from the unit 104 to determine an appropriate vacuum, and/or other information described below.

FIG. 2 depicts an overhead view of a vacuum unit interface 108 having a vacuum design 110. The design has a plurality of vacuum holes 112. As shown in FIG. 2, the design outlines the perimeter of the article and further includes vacuum holes in the center of the article. It is understood that this design is an embodiment and that the possible number of designs may be infinite. As shown in FIG. 2, the vacuum holes are circles. The vacuum holes may be any known regular or irregular geometric shape such as, for example, squares, stars, rectangles. The vacuum design may contain more than one geometric shape. As shown in FIG. 2, the vacuum unit interface has a first surface having a vacuum design with one or more vacuum holes. The vacuum holes are connected to a vacuum source (not shown) that may be turned on and off as needed by the manufacturing process.

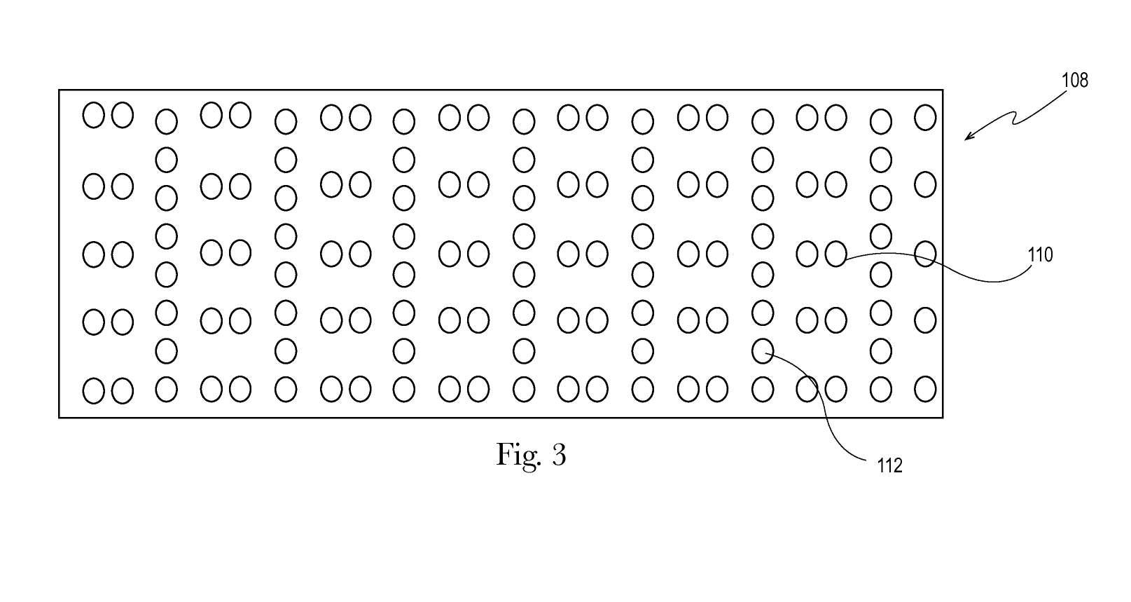

FIG. 3 depicts a second embodiment of an overhead view of a vacuum unit interface 108 having a vacuum design 110. The design has a plurality of vacuum holes 112. It is understood that this design is an embodiment and that the possible number of designs may be infinite. As shown in FIG. 3, the vacuum holes are circles.

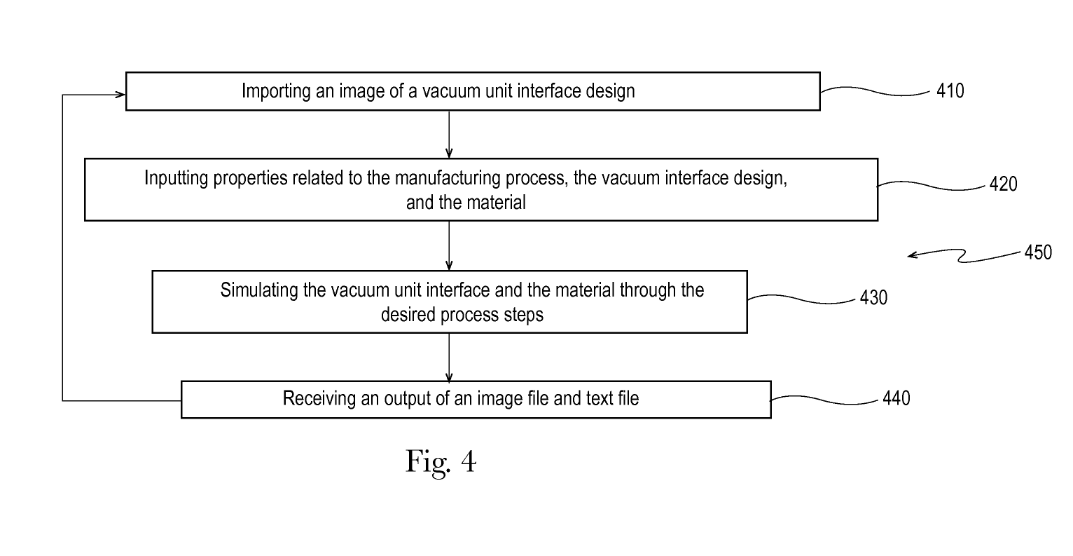

FIG. 4 depicts a flowchart 400 for determining an appropriate vacuum pattern to transport discrete products. To determine the appropriate vacuum pattern, an image is imported of the vacuum unit interface design 410. The method may further include inputting properties related to the manufacturing process and the material 420. The method further includes simulating the vacuum unit interface and the material through the desired process steps 430 and receiving an output of an image file and a text file 440. The output indicates whether there will be an issue with (1) the material not staying on the vacuum unit interface, (2) Edge lift-off of the material from the vacuum unit interface, and (3) Excessive deflection of material into the vacuum holes If the material shows any of the stated issues on the vacuum unit, the simulation may change or alter the image file for the vacuum unit interface.

The method includes importing an image of the vacuum unit interface design pattern superimposed on the discrete product 410. The image may be imported from a folder containing a plurality of image files or from a separate storage unit. Alternatively, the user may create an image file.

The image file may be any desirable dimension dependent upon the item or discrete article that will contact the vacuum unit interface. In an embodiment, the image file dimensions match an absorbent article. In a non-limiting embodiment, the image file dimensions match any individual component of an absorbent article, such as, for example, a backsheet of an absorbent article.

The method may further include inputting properties related to the manufacturing process, the vacuum unit, or the material that will contact the vacuum unit interface 420. Properties to be inputted may include, for example, an angle of attack or the angle between chord line and flight direction used for aerodynamic lift calculations, an elastic modulus for the material, a thickness for the material, a basis weight for the material, the vacuum unit interface velocity, the type of vacuum unit interface, process conditions such as a roll speed, a vacuum unit air density, a vacuum pressure exerted on the material, or combinations thereof. In a non-limiting embodiment, the material may have a modulus of elasticity between 0.0003 MPa to 10,000 MPa, such as, for example, between 0.001 MPa and 1,000 MPa, between 0.01 MPa and 100 MPa, or between 0.1 MPa and 50 MPa.

In an embodiment, the material may have a basis weight in grams per square meter and wherein the grams per square meter is between 0.01 to 50,000 gsm, such as, for example, 0.1 to 10,000 gsm, 1 to 1,000 gsm, or 10 to 100 gsm. The material may have a thickness of between 0.00001 to 1,000 mm, such as, for example, between 0.0001 to 100 mm, between 0.001 to 90 mm, between 0.01 to 50 mm, between 0.1 to 40 mm, or between 1 to 10 mm.

The method includes running a simulation based on the image file of the material overlaid with vacuum interface design from the vacuum unit and the input conditions 430. The simulation may be run using a python script which allows for ease of deployment and may be ran on multiple platforms such as, for example, Windows, Mac, Linux, mobile OS, etc.

The simulation may determine, using the image file and inputs, whether the vacuum unit and corresponding discrete product will have issues concerning the following factors:

the vacuum force being sufficient to hold the discrete product while accounting for centrifugal force, and aerodynamic lift forces,

if the vacuum unit interface design has vacuum holes that are the appropriate size to create the needed pressure while not pulling the material into the holes or below the first surface of the vacuum unit interface, and

the possibility of edge lift off by the material at the edges in contact with the vacuum unit interface. The simulation confirms the above three issues created by a high speed rotation or velocity with a surface speed between 0.01 and 1,000 m/s, such as, for example, between 0.1 m/s and 100 m/s, or between 1 m/s and 10 m/s.

The simulation may use to following calculations to determine the possibility of issues regarding the interaction between the vacuum unit and the material:

### Force Balance—Vacuum Force, Centrifugal Force and Aerodynamic Lift Force

Vacuum force is calculated by simply multiplying vacuum pressure at each hole (P_{vac}) with number of holes (N) and area of each hole.
Vacuum force=N*Pi*(r̂2)*P_{vac} (assuming there are N holes are circles with radius r)
Centrifugal Force, F_{cent}=M*V̂2/R_{drum} (M is mass of the material, the product, or a patch and V is the surface tangential velocity of the Vacuum unit), where R_{drum} is the drum or vacuum unit interface radius.
Aerodynamic lift force, F_{lift}=½*p*V̂2*A*C_{L}V is surface linear velocity, p is density of air, C_{L} is drag coefficient, A is the material area or the patch area or product area

### Edge Lift Off

This is calculated by using cantilever beam bending calculation
Max. Edge Lift-off=3*(F_{cent}+F_{lift})*L̂4/(2*E*t̂3)
Where L is the distance of the outer edge of material or patch to nearest vacuum hole, E is the modulus of elasticity or Young's Modulus for the material, t is thickness
Suction into the Holes
Is calculated by assuming a circular plate is fixed along the outside of the hole
Suction=0.1711*P_{vac}*(radiuŝ4)/E*t̂3)
Where P_{vac} is vacuum pressure at each hole, radius is radius of hole, E is the modulus of elasticity or Young's modulus for the material and t is thickness

After running the simulation, the method includes outputting a result in the form of an image file, a text file, or a combination of an image file and text file 440. The output may indicates whether there will be an issue with the material not staying on the vacuum unit interface, whether there will be any edge lift-off by the material from the vacuum unit interface, or the possibility for suction of the material into the holes or below the first surface of the vacuum unit interface. The system may analyze one or more factors of the output to determine if the current vacuum design and vacuum source are balanced for the given material. A balanced vacuum design and vacuum source represents that the vacuum unit interface and the material are maintained within the desired parameters for at least one of the factors being analyzed. In an embodiment, a balanced vacuum design and vacuum source represents that the vacuum unit interface and the material are maintained within the desired parameters for at least two or all three of the factors being analyzed. In an embodiment, acceptable parameters and the threshold for each parameter for each factor may be set by the user.

The image file may use color to allow the user to know whether the vacuum unit interface and the material will have an issue by color coding the image file so that the user may visually read the results. In an embodiment, the image file may show green for the portion of the material that will not have an issue, yellow for a portion of the material that may have an issue, and red for a portion of the material that will likely have an issue.

In an embodiment, the system may iterate to achieve desired targets such as for example, a vacuum force that is at least the same as the sum of the centrifugal force and lift force for the chosen material and manufacturing process, an edge lift-off of less than 0.5 mm by the material from the vacuum unit interface, and suction into the vacuum unit design holes by the material that is less than 10% of the hole diameter. The system may iterate by modifying a portion of or all of the image file or by changing some of the desired inputs such as, for example, vacuum hole pattern, vacuum pressure, vacuum hole size etc.

The inventors have found that the method allows for the creation of optimum vacuum hole pattern and required vacuum pressure for a given material and vacuum unit while eliminating costly trial and error.

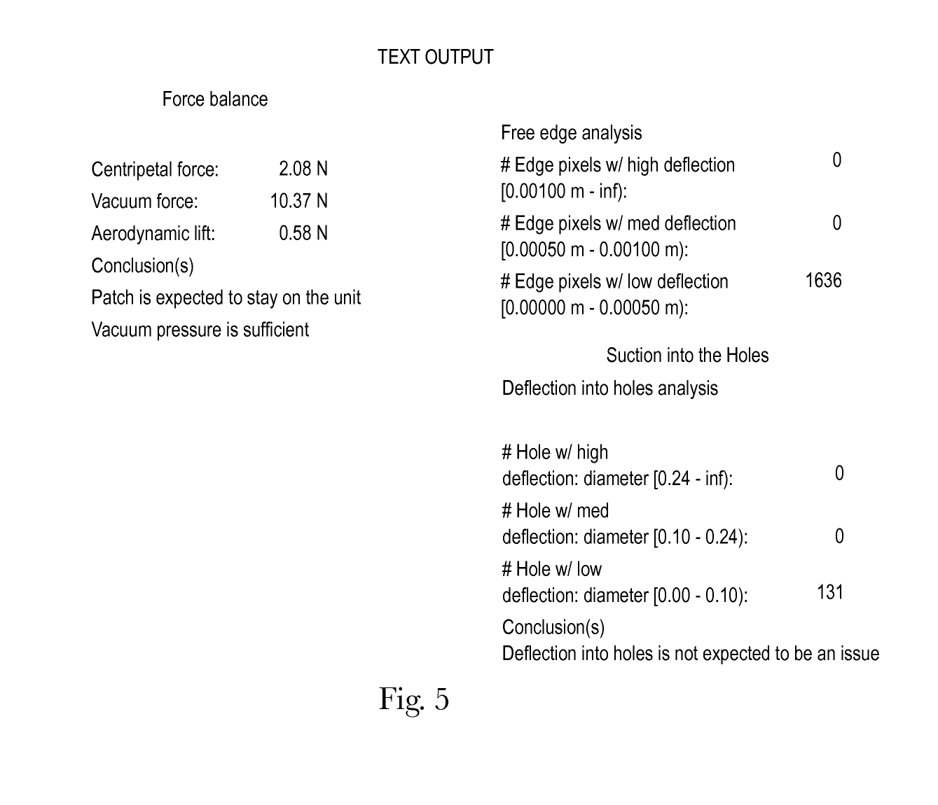

FIG. 5 depicts a text output for the simulation. As shown in FIG. 5, the output may include details regarding the three desired factors. The details may include a Force Balance, analysis regarding edge lift-off, and analysis regarding suction into the holes of the vacuum unit interface design. The output may also include a conclusion regarding the vacuum pressure and the material that will interact with the vacuum unit. The conclusion may be based on predetermined criteria for each of the three factors.

In an embodiment, the simulation calculates the amount of edge lift-off at each vacuum unit interface design hole. In an embodiment, if the edge lift-off is between 0 and 0.5 mm, the analysis reports an acceptable amount of edge lift-off. If the edge lift-off is between 0.5 mm and 1 mm for an individual vacuum unit interface design hole, then the simulation reports a caution for that individual vacuum unit interface design hole. If the edge lift-off is greater than 1 mm for an individual vacuum unit interface design hole, then the simulation reports a fail for that individual vacuum unit interface design hole. The system may report using a color coded system for each hole. In an embodiment, a green output equals an edge lift-off between 0 and 0.5 mm, a yellow output equals an edge lift-off between 0.5 and 1 mm, and a red output equals a fail.

In an embodiment, the simulation calculates the amount of suction into the holes of the material at each vacuum unit interface design hole. In an embodiment, if the suction into the holes of the material is between 0 and 10% of the hole diameter, the analysis reports an acceptable amount of suction into the holes. If the suction into the holes is between 10% and 24% of the hole diameter for an individual vacuum unit interface design hole, then the simulation reports a caution for that individual vacuum unit interface design hole. If the suction into the holes is greater than 24% of the hole diameter for an individual vacuum unit interface design hole, then the simulation reports a fail for that individual vacuum unit interface design hole. The system may report using a color coded system for each hole. In an embodiment, a green output equals a suction into the holes between 0 and 10%, a yellow output equals a suction into the holes between 10% and 24%, and a red output equals a fail.

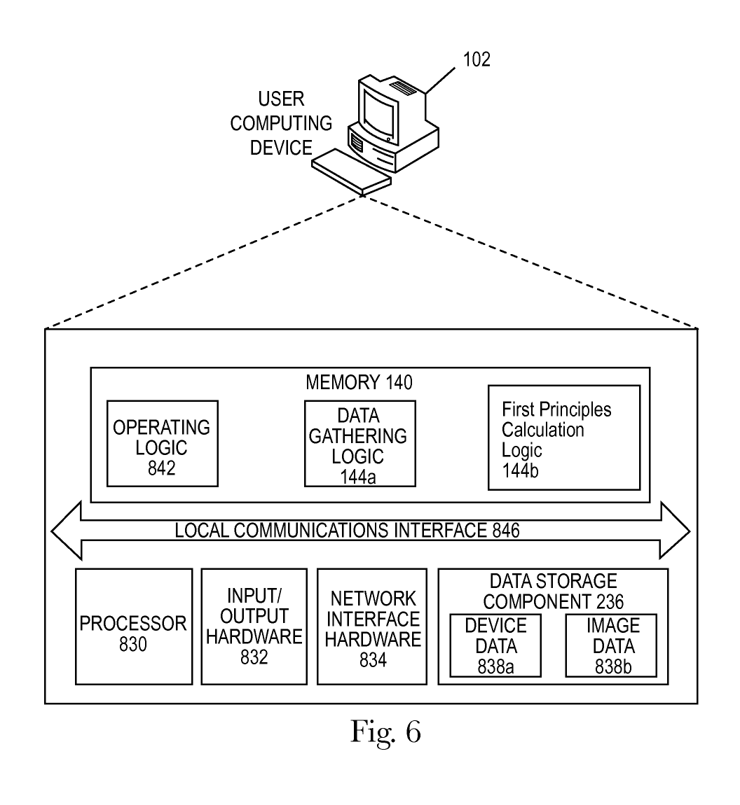

FIG. 6 depicts a user computing device 102 that may be utilized for predicting the performance of a vacuum unit on a material and/or product in manufacturing, according to embodiments disclosed herein. In the illustrated embodiment, the user computing device 102 includes a processor 830, input/output hardware 832, network interface hardware 834, a data storage component 236 (which stores device data 838a and pattern or image data 838b), and the memory component 140. The memory component 140 includes hardware and may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, the non-transitory computer-readable medium may reside within the user computing device 102 and/or external to the user computing device 102.

Additionally, the memory component 140 may be configured to store operating logic 842, the data gathering logic 144a, and the calculation logic 144b, each of which may be embodied as a computer program, firmware, and/or hardware, as an example. A local communications interface 846 is also included in FIG. 4 and may be implemented as a bus or other interface to facilitate communication among the components of the user computing device 102.

The processor 830 may include any hardware processing component operable to receive and execute instructions (such as from the data storage component 836 and/or memory component 140). The input/output hardware 832 may include and/or be configured to interface with a monitor, keyboard, mouse, printer, camera, microphone, speaker, and/or other device for receiving, sending, and/or presenting data. The network interface hardware 834 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the user computing device 102 and other computing devices.

Similarly, it should be understood that the data storage component 236 may reside local to and/or remote from the user computing device 102 and may be configured to store one or more pieces of data for access by the user computing device 102 and/or other components. In some embodiments, the data storage component 236 may be located remotely from the user computing device 102 and thus accessible via the network 100. In some embodiments however, the data storage component 236 may merely be a peripheral device, but external to the user computing device 102.

Included in the memory component 140 are the operating logic 842, the data gathering logic 144a, and the calculation logic 144b. The operating logic 842 may include an operating system and/or other software for managing components of the user computing device 102. Similarly, the data gathering logic 144a may be configured to cause the user computing device 102 to determine one or parameters related to the discrete article, the vacuum equipment design, the amount of vacuum.

It should be understood that the components illustrated in FIG. 4 are merely exemplary and are not intended to limit the scope of this disclosure. While the components in FIG. 4 are illustrated as residing within the user computing device 102, this is merely an example. In some embodiments, one or more of the components may reside external to the user computing device 102.

The system and method described herein may be used to predicting the performance of a vacuum unit on a material being transported or held within a manufacturing process. The vacuum unit may be modified based on the prediction of the simulation. The system and method described herein may also be used to design a vacuum unit for a predetermined step in a manufacturing process for a predetermined material. Once designed, the vacuum unit may be manufactured based on the simulation.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Values disclosed herein as ends of ranges are not to be understood as being strictly limited to the exact numerical values recited. Instead, unless otherwise specified, each numerical range is intended to mean both the recited values and any integers within the range. For example, a range disclosed as “1 to 10” is intended to mean “1, 2, 3, 4, 5, 6, 7, 8, 9, and 10.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A system for predicting the performance of a vacuum unit on a material being transported or held within a manufacturing process, comprising:
a vacuum unit comprising a vacuum source, a vacuum interface , and a vacuum interface design;
a material;
a computing device comprising a processor and a memory component, wherein the memory component stores logic that, when executed by the processor, causes the system to perform at least the following:
receive an image of the vacuum interface design;
receive one or more input properties of the material, the manufacturing process, the manufacturing process conditions, the vacuum unit or combinations thereof;
simulate the vacuum unit in contact with the material based on the inputs regarding the material and the manufacturing process;
output an analysis in the form of an image file, a text file, or an image file and a text file; and
analyze one or more factors to determine if the current vacuum design and vacuum source are balanced for the given material.

2. The system of claim 1, wherein the input properties of the material, the manufacturing process, the manufacturing process conditions, and the vacuum unit comprise of an angle of attack or the angle between chord line and flight direction used for aerodynamic lift calculations, an elastic modulus for the material, a thickness for the material, a basis weight for the material, the vacuum unit interface velocity, the type of vacuum unit interface, process conditions such as a roll speed, a vacuum unit air density, a vacuum pressure exerted on the material, or combinations thereof.

3. The system of claim 1, wherein simulating the vacuum unit in contact with the material accounts for centrifugal force, aerodynamic lift force, and vacuum force.

4. The system of claim 1, the one or more factors to determine if the current vacuum design and vacuum source comprise determining if the vacuum hold-down force is sufficient to hold a material against centrifugal and aerodynamic lift forces.

5. The system of claim 1, the one or more factors to determine if the current vacuum design and vacuum source comprises screening vacuum holes size and pressure will create excessive suction into the holes.

6. The system of claim 1, the one or more factors to determine if the current vacuum design and vacuum source comprises screening the holes pattern relative to the material edges for risk of edge lift off.

7. The system of claim 1, wherein the logic further causes the system to iterate until the simulation balances the forces.

8. The system of claim 1, wherein the vacuum source pressure is between 0.0001 atm and 1 atm.

9. The system of claim 1, wherein the logic further causes the system to iterate until suction into the holes is less than 10% of each hole diameter.

10. The system of claim 1, wherein the logic further causes the system to iterate until edge lift-off is less than 0.5 mm for each individual hole.

11. The system of claim 2, wherein the velocity of the vacuum interface is between 0.1 to 1,000 meters per second.

12. The system of claim 2, wherein the modulus of elasticity is between 0.003 MPa to 10,000 MPa.

13. The system of claim 1, wherein the basis weight for the material is in grams per square meter and wherein the grams per square meter is between 0.01 to 50,000.

14. The system of claim 1, wherein the material thickness is between 0.00001 to 1,000 mm.

15. A method of simulating a vacuum unit for a manufacturing process and a material being transported or held within the manufacturing process, comprising:
a computing device comprising a processor and a memory component, wherein the memory component stores logic that, when executed by the processor, causes the system to perform at least the following:
receive an image of a vacuum interface design;
receive one or more input properties of the material, the manufacturing process, the manufacturing process conditions, a vacuum unit or combinations thereof;
simulate the vacuum unit in contact with the material based on the inputs regarding the material and the manufacturing process;
output an analysis in the form of an image file, a text file, or an image file and a text file; and
analyze one or more factors to determine if the vacuum design and vacuum source are balanced for the given material.

16. The method of claim 15, wherein the method further comprises manufacturing a vacuum unit based on the output.

17. The method of claim 15, wherein the input properties of the material, the manufacturing process, the manufacturing process conditions, and the vacuum unit comprise of an angle of attack or the angle between chord line and flight direction used for aerodynamic lift calculations, a thickness for the material, a basis weight for the material, the vacuum unit interface velocity, the type of vacuum unit interface, process conditions such as a roll speed, a vacuum unit air density, a vacuum pressure exerted on the material, or combinations thereof.

18. The method of claim 15, wherein simulating the vacuum unit in contact with the material accounts for centrifugal force, aerodynamic lift force, and vacuum force.

19. The method of claim 15, the one or more factors to determine if the current vacuum design and vacuum source comprise determining if the vacuum hold-down force is sufficient to hold a material against centrifugal and aerodynamic lift forces.

20. The method of claim 15, the one or more factors to determine if the current vacuum design and vacuum source comprises screening vacuum holes size and pressure will create excessive suction into the holes.
